(19) United States
(12) Patent Application Publication
(10) Pub. No.: US 2026/0105839 A1
(43) Pub. Date: Apr. 16, 2026

(54) SYSTEMS AND METHODS FOR LANE INDICATION WITH USING BIRD'S EYE VIEW MAP

(71) Applicant: Toyota Motor Engineering & Manufacturing North America, Inc., Plano, TX (US)

(72) Inventors: Rohit Gupta, Santa Clara, CA (US); Qi Chen, San Jose, CA (US); Dawei Chen, Milpitas, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/916,347

(22) Filed: Oct. 15, 2024

(51) Int. Cl. G08G 1/0967; G06T 3/053; G06V 20/54; G08G 1/095; G08G 1/16

(52) U.S. Cl. CPC G08G 1/096741; G06T 3/053; G06V 20/54; G08G 1/095; G08G 1/167; G06V 2201/08

(57) ABSTRACT

Systems and methods for detecting one or more approaching vehicles include one or more processors and an infrastructure camera operable to capture one or more images of surroundings of an ego vehicle. The surroundings include a ramp, one or more lanes of a freeway, and the one or more approaching vehicles, and the ramp and the lanes share at least one merging point. The one or more processors operable to transform the one or more images of surroundings to a bird's eye view of the surroundings, generate a static segmentation map and one or more dynamic objects in the static segmentation map based on the bird's eye view, predict a lane occupancy of the ramp and the lanes based on range estimation of the ego vehicle and the one or more dynamic objects, and transmit information about the predicted lane occupancy to the ego vehicle.

### TECHNICAL FIELD

The present disclosure relates to systems and methods for geospatial mapping and advanced driving assistance, more specifically, to systems and methods for advancing vehicle driving assistance with real-time lane indication.

### BACKGROUND

The complexity of road configurations can lead to driver confusion and may impede the ability to make proper driving decisions, particularly in critical areas such as merging points. In such situations, drivers may struggle to interpret lane availability, upcoming traffic patterns, or how to integrate with moving traffic in a desired manner. Accordingly, a need exists for a system and method for real-time lane indication, enabling drivers to make informed and timely driving decisions.

### SUMMARY

In one embodiment, a method for detecting one or more approaching vehicles comprises transforming one or more images of surroundings of an ego vehicle captured by an infrastructure camera to a bird's eye view of the surroundings, wherein the surroundings include a ramp, one or more lanes of a freeway, and the one or more approaching vehicles, and the ramp and the lanes share at least one merging point, generating a static segmentation map and one or more dynamic objects in the static segmentation map based on the bird's eye view, predicting a lane occupancy of the ramp and the lanes based on range estimation of the ego vehicle and the one or more dynamic objects, and transmitting information about the predicted lane occupancy to the ego vehicle.

In another embodiment, a system for detecting one or more approaching vehicles includes one or more processors and an infrastructure camera operable to capture one or more images of surroundings of an ego vehicle. The surroundings include a ramp, one or more lanes of a freeway, and the one or more approaching vehicles, and the ramp and the lanes share at least one merging point. The one or more processors operable to transform the one or more images of surroundings to a bird's eye view of the surroundings, generate a static segmentation map and one or more dynamic objects in the static segmentation map based on the bird's eye view, predict a lane occupancy of the ramp and the lanes based on range estimation of the ego vehicle and the one or more dynamic objects, and transmit information about the predicted lane occupancy to the ego vehicle.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts an example system for enhanced lane indication with infrastructure assistance using a bird's eye view map for a road and a ramp of the present disclosure, in accordance with one or more embodiments shown and described herewith;

FIG. 1B schematically depicts an example system for enhanced lane indication with infrastructure assistance using a bird's eye view map for a road and multiple ramps of the present disclosure, in accordance with one or more embodiments shown and described herewith;

FIG. 2 schematically depicts example components of the system for enhanced lane indication with infrastructure assistance using a bird's-eye view map of the present disclosure, according to one or more embodiments shown and described herein;

FIG. 3 depicts a block diagram of generating enhanced lane indication of the present disclosure, according to one or more embodiments shown and described herein;

FIG. 4 schematically depicts an example segmentation map of the present disclosure, according to one or more embodiments shown and described herein; and

FIG. 5 depicts a flowchart for illustrative steps for enhanced lane indication with infrastructure assistance using the bird's-eye view map of the present disclosure, according to one or more embodiments shown and described herein.

### DETAILED DESCRIPTION

The embodiments disclosed herein include systems and methods for enhanced lane indication and approaching vehicles with infrastructure assistance using a bird's-eye view map. The disclosed systems use one or more infrastructure cameras to capture images of surroundings around a merging point of a freeway and a ramp. The freeway and/or the ramp may include one or more lanes. The systems may transfer the images to a bird's-eye view of the surroundings and further generate a static segmentation map and one or more dynamic objects in the static segmentation map based on the bird's eye view. The systems may then predict a lane occupancy of the ramp and the lanes based on range estimation and further provide the lane occupancy information to interested vehicles.

The visual field of drivers and vehicles on ramps is often intermittently obstructed or influenced by various obstacles, such as trees, road complexity (e.g., interchanges, elevated ramps), and lighting conditions (e.g., sunlight, streetlights). These factors can impair a driver's ability to clearly see other vehicles and make informed decisions, particularly when it comes to lane merging. For instance, drivers may struggle to discern which lanes on the main road or ramp are occupied by approaching vehicles, making it difficult to make desirable merging decisions.

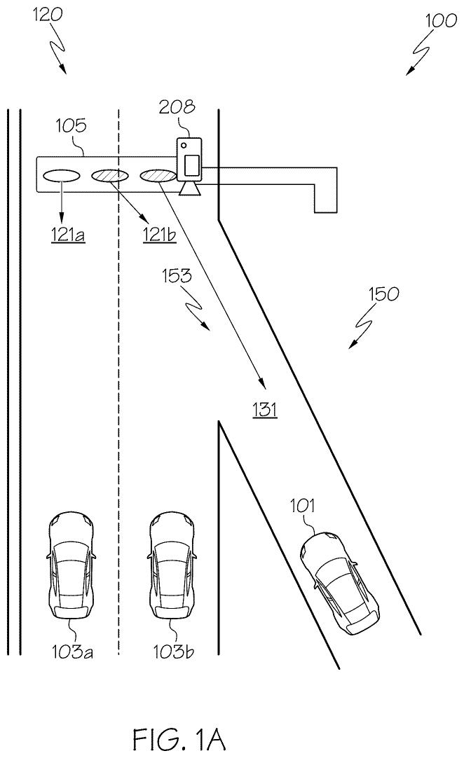

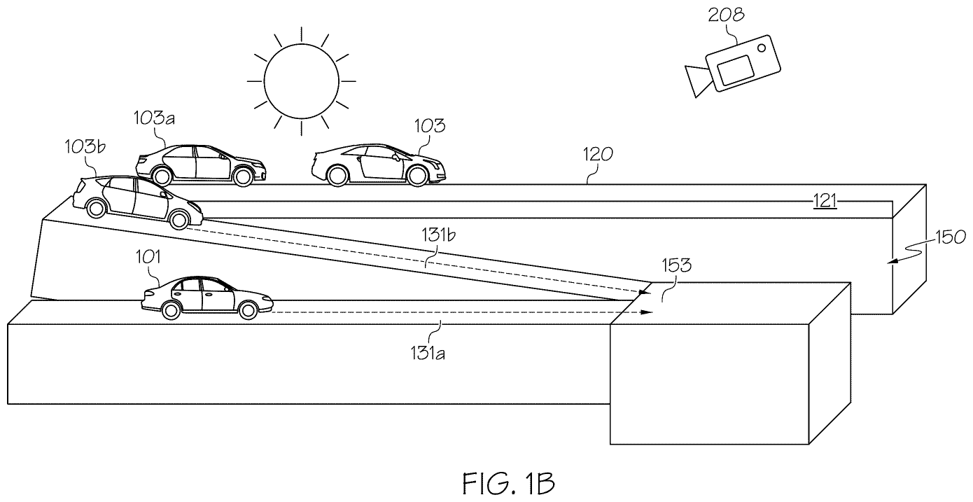

Consider the scenario depicted in FIG. 1B, where a complex road configuration features multiple ramps and freeways. In this situation, a vehicle on a lower ramp and another vehicle exiting a freeway on an elevated ramp may both be approaching the same merging point at a ramp junction. The driver of the vehicle on the lower ramp may be unable to detect the vehicle on the elevated ramp due to visual obstructions such as the ramp structure itself and sunlight. Moreover, the driver may become confused as to whether the vehicle on the elevated ramp is still on the freeway or actively approaching the ramp due to the presence of multiple vehicles on the highway. Similarly, in the scenario depicted in FIG. 1A, the driver of a vehicle driving from a ramp to merge into a freeway can be confused whether a vehicle approaching the merging point is on the right lane or on the left lane.

The disclosed systems and methods address these challenges by utilizing enhanced lane indication, supported by infrastructure-assisted technology and bird's-eye view mapping. An infrastructure camera monitors lane occupancy, capturing real-time images of the lanes without interference from obstacles such as ramps or lighting. This can provide more complete and accurate information regarding lane usage. Through image processing techniques, including bird's-eye view mapping and segmentation, a dynamic illustration of lane activity is produced, allowing drivers to better understand which lanes are occupied and make informed merging decisions. Consequently, these systems and methods can significantly improve the driving experience on complex roadways by providing clear lane indication information, reducing confusion, and enhancing the overall experience for vehicles navigating ramps.

As used herein, the singular forms “a,” “an” and “the” include plural referents unless the context clearly dictates otherwise. Thus, for example, reference to “a” component includes aspects having two or more such components unless the context clearly indicates otherwise. Whenever possible, the same reference numerals will be used throughout the drawings to refer to the same or like parts.

Turning to figures, FIGS. 1A and 1B depict an example enhanced lane indication system 100 for enhanced lane indication with infrastructure assistance using a bird's eye view map of the present disclosure. The enhanced lane indication system 100 may include an infrastructure camera 208 and a lane indicator light 105. The infrastructure camera 208 may capture one or more images of surroundings 150 of an ego vehicle 101. The surroundings 150 may include, among others, a ramp 131, one or more lanes 121 of a freeway 120, and one or more non-ego vehicles 103. The ramp 131 and the lanes 121 may share at least one merging point 153. In some embodiments the ego vehicle 101 may move on the ramp 131 to merge into the freeway 120 at the merging point 153 when one or more non-ego vehicles 103 may move on the freeway 120 that may cause potential conflict and/or collision with the ego vehicle 101 at the merging point 153 (e.g., as in FIG. 1A). In some embodiments, one or more non-ego vehicles 103 may leave from the freeway 120 to merge into a ramp 131b or a road at the merging point 153 when the ego vehicle 101 moves on the ramp 131a or the road that a potential conflict and/or collision may exist at the merging point 153 (e.g., as in FIG. 1B).

In embodiments, the infrastructure camera 208 may include a selection of, without limitations, a camera, a proximity sensor, a light detection and ranging (LIDAR) sensor, a thermal image sensor, an infrared sensor, an ultrasonic sensor, and/or a combination thereof. The camera may be, without limitation, a red, green, and blue (RGB) camera, a depth camera, an infrared camera, a wide-angle camera, or a stereoscopic camera. The infrastructure camera 208 may be any device having an array of sensing devices capable of detecting radiation in an ultraviolet wavelength band, a visible light wavelength band, or an infrared wavelength band. The infrastructure camera 208 may have any resolution. In some embodiments, one or more optical components, such as a mirror, fish-eye lens, or any other type of lens may be optically coupled to the infrastructure camera 208. The infrastructure camera 208 may be arranged around the merging point 153 to capture images of the surroundings 150. In some embodiments, the infrastructure camera 208 may be mounted on a fixated structure, such as, without limitation, a traffic light pole and a lane indicator light 105. In some embodiments, the infrastructure camera 208 may be mounted on a moving object, such as, without limitation, a drone. The images may include a perspective view of the surroundings 150, such as a two-dimensional (2D) representation.

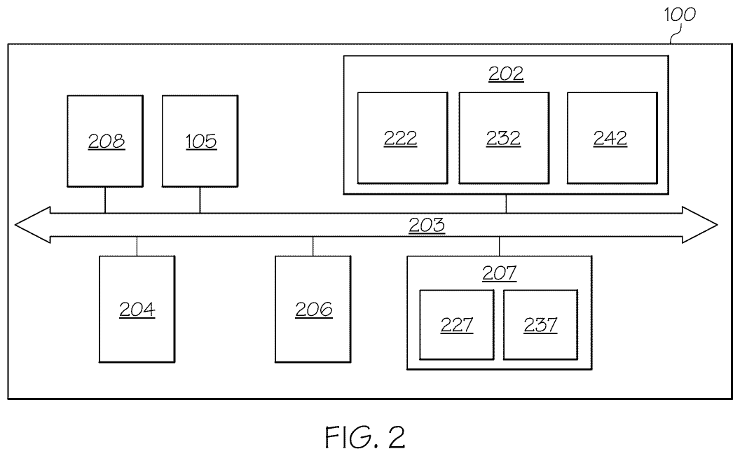

In some embodiments, the enhanced lane indication system 100 may include one or more modules, such as a vision transformer module 222, a segmentation map module 232, and a lane occupancy module 242 (as illustrated in FIG. 2). The vision transformer module 222 may transform the perspective view into a bird's-eye view perception with a three-dimensional (3D) representation. The segmentation map module 232 may use the bird's-eye view perception to generate a static segmentation map representing static objects in the surroundings 150 and detect one or more dynamic objects, such as vehicles (e.g., the ego vehicle 101 and the non-ego vehicles 103), pedestrians, or other moving objects. The lane occupancy module 242 may determine and/or predict occupancy status based on the range estimation of the ego vehicle 101 and the dynamic objects for each lane 121 of the freeway 120 and the ramp 131. In some embodiments, the occupancy status may include an occupied status and an unoccupied status, and transmit information about the lane. In some embodiments, the enhanced lane indication system 100 may operate the ego vehicle 101 and/or at least one non-ego vehicle 103 to avoid potential conflict/collision at the merging point 153.

The vision transformer module 222, the segmentation map module 232, and/or the lane occupancy module 242 may include one or more machine-learning (ML) algorithms. The one or more vehicle modules may be pre-trained using training data of the range estimation and lane occupancy, including ground-truth examples and scenarios where multiple entities (e.g. one or more ego vehicles 101, a plurality of non-ego vehicles 103, and other objects move on roads, ramps, or other surfaces while considering the positions of one or more centered entities and the other entities, operation conditions of the entities (for example, the speed, the direction, the acceleration, the reactions to other entities of the entities), distances between the entities, and factors (for example, without limitation, environments, weather, road conditions, etc.). The pre-training may include labeling the entities and desirable lane occupancy prediction of the lanes and ramps results in the examples and scenarios and using one or more ML models to learn to predict the desirable and undesirable lane occupancy prediction results based on the training data. The pre-training may further include fine tuning, evaluation, and testing steps. The one or more modules may be continuously trained using the real-world collected data to adapt to changing conditions and factors and improve the performance over time. The one or more modules may be continuously trained during the operation of the enhanced lane indication system 100, using the collected data and generated data, such as historical static segmentation map 227 and/or historical bird's-eye view images 237 (as in FIG. 2).

In some embodiments, the enhanced lane indication system 100 may include the lane indicator light 105. The lane indicator light 105 may include a plurality of indicator lights, each representing a lane 121 of the freeway 120 and/or the ramp 131. Each indicator light may indicate the occupancy status of the corresponding lane. The occupied status may refer to at least one vehicle 101 or 103 approaching the area around the merging point 153 based on analysis results from lane occupancy module 242, such as range estimation. Accordingly, it should be appreciated that, when the vehicles 101, 103 are far away from the merging point 153 or pass the merging point 153 in one of the lanes 121, the lane indicator light 105 may have a corresponding indicator light in a color or a pattern suggesting an unoccupied status for the corresponding lane 121. The arrangement of the indicator lights may follow the same sequence as the arrangement of the lanes of the freeway 120 and/or the ramp 131. For example, as illustrated in FIG. 1A, the left indicator light of the lane indicator light 105 may represent the occupancy status of the left lane 121a, the middle indicator light of the lane indicator light 105 may represent the occupancy status of the right lane 121b, and the right indicator light of the lane indicator light 105 may represent the occupancy status of the ramp 131. The lane indicator light 105 may be arranged above the freeway 120 and/or the ramp 131 near the merging point 153 such that the drivers of the ego vehicle 101 and/or the non-ego vehicle 103 can see the occupancy status.

In embodiments, one or more vehicles 101, 103 may move on the freeway 120 and/or the ramp 131. The vehicles 101, 103 may be an automobile or any other passenger or non-passenger vehicle such as, for example, a terrestrial, aquatic, and/or airborne vehicle. Each vehicle may be an autonomous vehicle or a semi-autonomous vehicle that navigates its environment with limited human input or without human input. The vehicles 101, 103 may drive on a road and perform vision-based lane centering, e.g., using a sensor. The vehicles 101, 103 may include actuators for driving the vehicle, such as a motor, an engine, or any other powertrain. The vehicles 101, 103 may move on various surfaces, such as, without limitations, roads, highways, streets, expressways, bridges, tunnels, parking lots, garages, off-road trails, railroads, or any surfaces where the vehicles may operate. As illustrated in FIGS. 1A and 1B, the ego vehicle 101 may move on a non-limiting example ramp 131 merging to another road or ramp 131. It should be appreciated that, in some embodiments, the ego vehicle 101 and/or the non-ego vehicles 103 may move on the freeway 120 including multiple lanes 121. For example, the freeway 120 may include a left lane 121a and a right lane 121b to the north direction. The non-ego vehicle 103a may move on the left lane 121a that do not interact with the merging point 153, and the non-ego vehicle 103b may move on the right lane 121b that leads to the merging point. The vehicles 101, 103 moving on the freeway 120 may move within a lane or change lanes to another lane moving in the same direction. It should be appreciated that each vehicle 101, 103 may be considered as an ego vehicle 101 while other vehicles being the non-ego vehicles 103. Accordingly, throughout the disclosure, when applicable, the description related to the ego vehicle 101 can apply to the non-ego vehicles 103.

The ego vehicle 101 may include one or more proximity sensors and vehicle steering sensors to capture data for autonomous or semi-autonomous navigation and maneuvers of the ego vehicle 101. The proximity sensors and the vehicle steering sensors may be used to collect and generate environmental data and vehicle steering data, such as a time gap and/or a distance gap between the ego vehicle 101 and objects in the surroundings 150, the acceleration of the ego vehicle 101, the velocity of the ego vehicle 101, and the velocity of the non-ego vehicle 103, current location of the ego vehicle 101, contextual information, such as weather information, a type of the road on which the ego vehicle 101 is driving, a surface condition of the freeway 120 and the ramp 131 on which the ego vehicle 101 is driving, and a degree of traffic on the freeway 120 on which the ego vehicle 101 is driving. The environmental data may include weather conditions (e.g., sunny, rain, snow, or fog), road conditions (e.g., dry, wet, or icy road surfaces), traffic conditions, road infrastructure, obstacles (e.g., non-ego vehicles 103 or pedestrians), lighting conditions, geographical features of the freeway 120, and other environmental conditions related to driving on the freeway 120 and the ramp 131.

In some embodiments, the one or more proximity sensors of the ego vehicle 101 may include a selection of, without limitations, a camera, a light detection and ranging (LIDAR) sensor, a thermal image sensor, an infrared sensor, an ultrasonic sensor, and/or a combination thereof. The camera may be, without limitation, a red, green, and blue (RGB) camera, a depth camera, an infrared camera, a wide-angle camera, or a stereoscopic camera. The one or more proximity sensors may be any device having an array of sensing devices capable of detecting radiation in an ultraviolet wavelength band, a visible light wavelength band, or an infrared wavelength band. The one or more proximity sensors may have any resolution. In some embodiments, one or more optical components, such as a mirror, fish-eye lens, or any other type of lens may be optically coupled to the one or more proximity sensors. In some embodiments, the one or more vehicle steering sensors of the ego vehicle 101 may include one or more speed sensors or motion sensors for detecting and measuring motion and changes in motion of the ego vehicle 101. The motion sensors may include inertial measurement units. Each of the one or more motion sensors may include one or more accelerometers and one or more gyroscopes. Each of the one or more motion sensors transforms the sensed physical movement of the vehicle into a signal indicative of an orientation, a rotation, a velocity, or an acceleration of the vehicle. The acquired data from the vehicle steering sensors may be used to determine the vehicle kinematics of the ego vehicles 101. Accordingly, the vehicle steering sensors may be used to collect and generate vehicle control data and vehicle kinematic data. The vehicle control data may include throttle position, brake status, steering angle, and gear selection. The vehicle kinematic data may include velocity, acceleration, position, and orientation.

FIG. 2 schematically depicts example components of the enhanced lane indication system 100. The enhanced lane indication system 100 may include one or more processors 204. Each of the one or more processors 204 may be any device capable of executing machine-readable and executable instructions. The instructions may be in the form of a machine-readable instruction set stored in data storage component 207 and/or the memory component 202. Accordingly, each of the one or more processors 204 may be a controller, an integrated circuit, a microchip, a computer, or any other computing device. The one or more processors 204 are coupled to a communication path 203 that provides signal interconnectivity between various modules of the system. Accordingly, the communication path 203 may communicatively couple any number of processors 204 with one another, and allow the modules coupled to the communication path 203 to operate in a distributed computing environment. Specifically, each of the modules may operate as a node that may send and/or receive data. As used herein, the term “communicatively coupled” means that coupled components are capable of exchanging data signals with one another such as, for example, electrical signals via a conductive medium, electromagnetic signals via air, optical signals via optical waveguides, and the like.

Accordingly, the communication path 203 may be formed from any medium that is capable of transmitting a signal such as, for example, conductive wires, conductive traces, optical waveguides, or the like. In some embodiments, the communication path 203 may facilitate the transmission of wireless signals, such as WiFi, Bluetooth®, Near Field Communication (NFC), and the like. Moreover, the communication path 203 may be formed from a combination of mediums capable of transmitting signals. In one embodiment, the communication path 203 comprises a combination of conductive traces, conductive wires, connectors, and buses that cooperate to permit the transmission of electrical data signals to components such as processors, memories, sensors, input devices, output devices, and communication devices. Accordingly, the communication path 203 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square-wave, vibration, and the like, capable of traveling through a medium.

The enhanced lane indication system 100 may include one or more memory components 202 coupled to the communication path 203. The one or more memory components 202 may comprise RAM, ROM, flash memories, hard drives, or any device capable of storing machine-readable and executable instructions such that the machine-readable and executable instructions can be accessed by the one or more processors 204. The machine-readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored on the one or more memory components 202. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 204 along with the one or more memory components 202 may operate as a controller for the enhanced lane indication system 100.

The one or more memory components 202 may include the vision transformer module 222, the segmentation map module 232, and the lane occupancy module 242. Each of the modules 222, 232, and 242 may include, but are not limited to, routines, subroutines, programs, objects, components, data structures, and the like for performing specific tasks or executing specific data types as will be described below. The data storage component 207 stores the historical static segmentation map 227, the historical bird's-eye view images 237, data generated by the sensors, and data of operating the lane indicator light 105 and the infrastructure cameras 208. The vision transformer module 222, the segmentation map module 232, and the lane occupancy module 242 may also be stored in the data storage component 207 during operating or after operation. Each of the modules may include one or more machine-learning algorithms. The vehicle modules and the server modules may be trained and provided with machine learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one-to-one, one-to-many, many-to-one, and/or many-to-many (e.g., sequence to sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in a field of machine learning, for example, is a class of deep, feed-forward ANNs applied for audio analysis of the recordings. CNNs may be shift or space invariant and utilize shared-weight architecture and translation. Further, each of the various modules may include a generative artificial intelligence algorithms. The generative artificial intelligence algorithm may include a general adversarial network (GAN) that has two networks, a generator model and a discriminator model. The generative artificial intelligence algorithm may also be based on variation autoencoder (VAE) or transformer-based models.

Referring still to FIG. 2, the enhanced lane indication system 100 may include one or more infrastructure cameras 208. The one or more infrastructure cameras 208 may include a selection of, without limitations, a proximity sensor, a camera, a light detection and ranging (LIDAR) sensor, a thermal image sensor, an infrared sensor, an ultrasonic sensor, and/or a combination thereof. The camera may be, without limitation, a red, green, and blue (RGB) camera, a depth camera, an infrared camera, a wide-angle camera, or a stereoscopic camera. The one or more infrastructure cameras 208 may be any device having an array of sensing devices capable of detecting radiation in an ultraviolet wavelength band, a visible light wavelength band, or an infrared wavelength band. The one or more infrastructure cameras 208 may have any resolution. In some embodiments, one or more optical components, such as a mirror, fish-eye lens, or any other type of lens may be optically coupled to the one or more infrastructure cameras 208. In embodiments described herein, the one or more infrastructure cameras 208 may provide image data to the one or more processors 204 or another component communicatively coupled to the communication path 203. In some embodiments, the one or more infrastructure cameras 208 may also provide navigation support. That is, data captured by the one or more infrastructure cameras 208 may be used to autonomously or semi-autonomously navigate a vehicle.

The enhanced lane indication system 100 may include network interface hardware 206 for communicatively coupling the enhanced lane indication system 100 to the vehicles 101, 103 and/or a server. The network interface hardware 206 can be communicatively coupled to the communication path 203 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol.

The enhanced lane indication system 100 may include the infrastructure camera 208. The infrastructure camera 208 can be communicatively coupled to the communication path 203. The infrastructure camera 208 may include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain rough depth and speed information for the view of the surroundings 150.

The enhanced lane indication system 100 may include one or more lane indicator lights 105. The lane indicator light 105 can be communicatively coupled to the communication path 203. The lane indicator light 105 may include a plurality of indicator lights, each representing a lane 121 of the freeway 120 and/or the ramp 131. The indicator lights may include, without limitation, bulbs, light-emitting diode (LED) lights, and electroluminescent lights. The indicator lights may be mono-color lights or multi-color lights. The lane indicator light 105 may use a shape, a color, or a light pattern (e.g., steady and flashing) to indicate the occupancy status of the corresponding lanes and ramp. The lane indicator light 105 may further include digital display signs, traffic control signals, and other components/devices regarding lane indication.

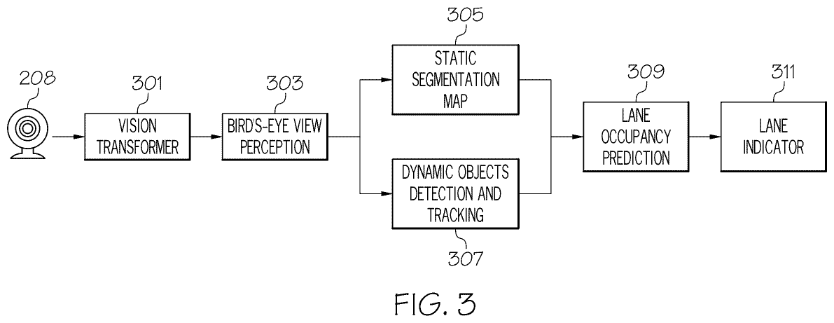

FIG. 3 depicts an example block diagram of generating enhanced lane indication of the present disclosure. The enhanced lane indication system 100 may capture, using the one or more infrastructure cameras 208, one or more images of the surroundings 150 around near the merging point 153 and/or the ego vehicle 101, including the images and/or video frames of the surroundings 150.

At block 301, the vision transformer module 222 (in FIG. 2) may transfer the images from a 2D perspective view to a 3D bird's-eye view. The vision transformer module 222 may estimate the depth information from the images, reconstruct the surrounding scene in 3D, and then change the perspective to a top-down view (i.e., the bird's eye view). The depth estimation may be performed based on monocular depth prediction to infer the distance of each pixel of the images. In some embodiments, the depth information and data may be estimated from images generated by a single infrastructure camera. In some embodiments, the depth information and data may be generated based on two or more infrastructure cameras 208 at different locations. In some embodiments, the depth information and data may be provided from distance sensors like a LiDAR sensor. The vision transformer module 222 may then create a depth map with 3D point cloud, where each pixel in the 2D may be projected into the 3D space. The vision transformer module 222 may then perform a geometric transformation to view the surrounding scene from above (i.e., from bird's eyes) and generate the 3D bird's-eye view perception at block 303.

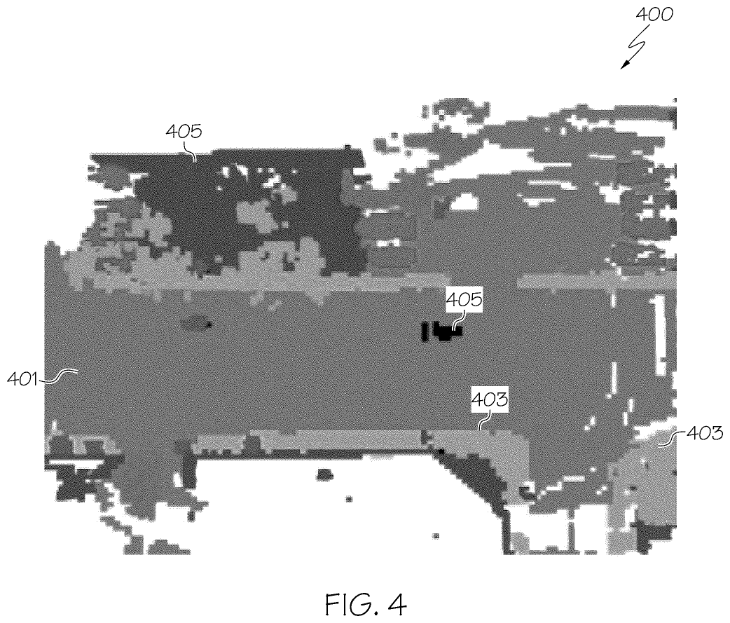

At blocks 305 and 307, the segmentation map module 232 may perform segmentation mapping to the generated bird's-eye perception images to generate one or more segmentation images 400 (e.g., in FIG. 4). The segmentation images may include background 401 (e. g, in FIG. 4), static objects 403 (e.g., in FIG. 4), and dynamic objects 405 (e.g., in FIG. 4) in the surroundings 150. At block 305, the segmentation map module 232 may perform a semantic segmentation mapping on the bird's-eye view perception to generate a static segmentation map by leveraging bird's eye view perception. The segmentation map module 232 may classify each pixel in the bird's-eye view perception into a category based on its semantic features, such as color or placement. The segmentation map module 232 may compare a current bird's-eye view perception with historical bird's-eye view perceptions and/or an existing free-space map of the surroundings 150 to determine the objects as static objects 403 or dynamic objects 405. The segmentation map module 232 may generate a free-space map of the surroundings if none of such exists, or/and continuously update the free-space map with more captured images. The segmentation map module 232 may include an ML algorithm, such as one or more deep learning models like Mask R-CNN, DeepLab, or U-Net. The ML algorithm can segment the bird's-eye view image into meaningful classes, such as, without limitation, roads, sidewalks, buildings, vehicles, vegetation, and any objects and structures around the merging point 153. After the segmentation, the background 401 and static objects 403, like road surface, and road boundary, may be extracted, filtered, and/or classified (e.g., free-space, road, obstacle, etc). The segmentation map module 232 may assign different values and/or colors for each class and generate the static segmentation map (e.g., a semantic segmentation map) at block 305. It should be appreciated that, in some embodiments, other segmentation technology can be used to generate the static segmentation map, such as, without limitation, instance segmentation, panoptic segmentation, depth segmentation, superpixel segmentation, region-based segmentation, and edge-based segmentation.

In some embodiments, the segmentation map module 232 may determine and classify the background 401 and static objects 403 as the lanes 121, lane markings, and other relevant features (e.g., road boundaries and curbs). The segmentation map module 232 may create a bindery mask with pixels corresponding to lane markings and lane boundaries, and classify the areas in the segmentation map as lane-area and non-lane area. The segmentation map module 232 may mark each lane 121 and ramp 131, such as the lane 121a, the lane 121b, (e.g., in FIG. 1A) ramp 131a, and ramp 131b (e.g., in FIG. 1B). The segmentation map module 232 may label regions representing static objects 403 and structures of roads (e.g., road boundary). The labeled regions may include one or more background 401, one or more lane mark regions, and one or more road boundary regions. In some embodiments, when the lane marks are missing, the segmentation map module 232 may perform lane number and lane width estimation to determine the lane area for each lane 121.

In block 307, the segmentation map module 232 may further detect, classify, and track dynamic objects, such as the vehicles 101, 103, pedestrians, cyclists, motorcycles, and/or other moving objects in the bird's-eye view perception. The segmentation map module 232 may detect the dynamic objects by comparing the bird's-eye view map with the static segmentation map generated in the block 305. The segmentation map module 232 may include a neural network (e.g., a YOLOv5) to generate a set of object detections with objects. In some embodiments, the segmentation map module 232 may implant one or more bounding boxes to the detected dynamic objects in bird's-eye view perception, where each dynamic object can be described with a bounding box, a class (e.g., an approaching vehicle to the merging point 153, a vehicle passing the merging point 153, and the like), a detection confidence score between 0 and 1.

At block 309, the lane occupancy module 242 may perform a lane occupancy prediction based on the static segmentation map generated in block 305 and the dynamic objects detection and tracking generated in block 307. The lane occupancy module 242 may identify and segment lanes 121 and ramps 131 in the bird's-eye view perception, recognize the pixels corresponding to the lanes 121 and ramps 131, and create one or more binary lane masks that highlight the lane boundaries. The lane occupancy module 242 may have a convolutional neural network (CNN) architecture with an encoder, a decoder, and a backbone (e.g., UNetFormer). The lane occupancy module 242 may extract the pixel of the bird's-eye view perception and assign each of the pixels a corresponding label to the corresponding static segmentation map, indicating whether the pixel may belong to a certain lane/ramp or not. Based on the corresponding lane mask the lane occupancy module 242 may add a lane index to each detected dynamic objects 405. For example, the enhanced lane indication system 100 may know whether a non-ego vehicle 103 is driving on one lane 121b in FIG. 1A or one ramp 131b in FIG. 1B approaching the merging point 153 that may cause a conflict with the ego vehicle 101, or whether the non-ego vehicle 103 has passed the merging point 153 or on a lane 121 (e.g., the left lane 121a) that would not cause a potential collision.

At block 311, the lane occupancy module 242 may output a lane indication. The lane occupancy module 242 may predict a lane occupancy of the ramp 131 and the lanes 121 based on the range estimation of the ego vehicle 101 and the one or more dynamic objects 405. The enhanced lane indication system 100 may transmit information about the predicted lane occupancy to the ego vehicle 101. In some embodiments, the enhanced lane indication system 100 may display the lane occupancy on the lane indicator light 105.

In some embodiments, the lane occupancy module 242 may predict the moving speeds of the one or more dynamic objects 405 and relative distances between the ego vehicle 101 and the one or more dynamic objects 405 based on the current segmentation map and one or more past segmentation maps. The lane occupancy module 242 may predict collision probability between the ego vehicle 101 and each of the one or more dynamic objects 405 based on the lane occupancy, the moving speeds of the one or more dynamic objects 405, and the relative distances between the ego vehicle 101 and the one or more dynamic objects 405. The lane occupancy module 242 may then determine whether the collision probability is beyond a threshold probability. The threshold probability may be a preset value or a value determined based on historical collision events or/and historical near collision events near the merging point 153. In response to determining that the collision probability is beyond the threshold probability, the lane occupancy module 242 may warn the ego vehicle 101 of a potential collision with at least one of the one or more dynamic objects 405. In some embodiments, in response to determining that the collision probability is beyond the threshold probability, the enhanced lane indication system 100 may operate the ego vehicle to avoid the potential collision.

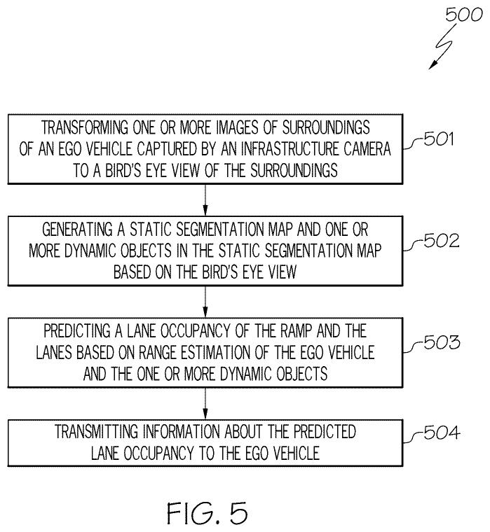

FIG. 5 depicts an illustrative example method 500 for enhanced lane indication with infrastructure assistance using a bird's eye view map. At block 501, the method 500 includes transforming one or more images of surroundings 150 (in FIGS. 1A and 1B) of an ego vehicle 101 (in FIGS. 1A and 1B) captured by an infrastructure camera 208 (in FIGS. 1A and 1B) to a bird's eye view of the surroundings 150. The surroundings 150 may include a ramp 131 (in FIGS. 1A and 1B), one or more lanes 121 (in FIGS. 1A and 1B) of a freeway 120 (in FIGS. 1A and 1B), and the one or more non-ego vehicles 103 (in FIGS. 1A and 1B). The non-ego vehicles 103 may include an approaching vehicle. The ramp 131 and the lanes 121 may share at least one merging point 153 (in FIGS. 1A and 1B). At block 502, the method 500 includes generating a static segmentation map and one or more dynamic objects 405 (e.g., as in FIG. 4) in the static segmentation map based on the bird's eye view. At block 503, the method 500 includes predicting a lane occupancy of the ramp 131 and the lanes 121 based on range estimation of the ego vehicle 101 and the one or more dynamic objects 405. At block 504, the method 500 includes transmitting information about the predicted lane occupancy to the ego vehicle 101.

In some embodiments, the static segmentation map may include labeled regions representing static objects 403 and structures of roads. The static segmentation map may include one or more background 401, one or more lane mark regions, and one or more road boundary regions. The dynamic objects 405 may represent moving objects in the surroundings 150. The moving objects may include moving vehicles 101, 103 and pedestrians on the freeway 120 and the ramp 131. The infrastructure camera 208 may be located at or near the merging point 153. the static segmentation map and the dynamic objects may be generated further based on historical static segmentation maps of the surroundings.

In some embodiments, the method 500 may further include displaying the lane occupancy on a lane indicator light 105. In some embodiments, the method 500 may further include predicting moving speeds of the one or more dynamic objects 405 and relative distances between the ego vehicle 101 and the one or more dynamic objects 405. In some embodiments, the method 500 may further include predicting collision probability between the ego vehicle 101 and each of the one or more dynamic objects 405 based on the lane occupancy, the moving speeds of the one or more dynamic objects 405, and the relative distances between the ego vehicle 101 and the one or more dynamic objects 405 In some embodiments, the method 500 may further include determining whether the collision probability is beyond a threshold probability, and in response to determining that the collision probability is beyond the threshold probability, warning the ego vehicle 101 of a potential collision with at least one of the one or more dynamic objects 405. In some embodiments, the method 500 may further include in response to determining that the collision probability is beyond the threshold probability, operating the ego vehicle to avoid the potential collision.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for detecting one or more approaching vehicles comprising:
transforming one or more images of surroundings of an ego vehicle captured by an infrastructure camera to a bird's eye view of the surroundings, wherein the surroundings include a ramp, one or more lanes of a freeway, and the one or more approaching vehicles, and the ramp and the lanes share at least one merging point;
generating a static segmentation map and one or more dynamic objects in the static segmentation map based on the bird's eye view;
predicting a lane occupancy of the ramp and the lanes based on range estimation of the ego vehicle and the one or more dynamic objects; and
transmitting information about the predicted lane occupancy to the ego vehicle.

2. The method of claim 1, wherein the static segmentation map comprises labeled regions representing static objects and structures of roads.

3. The method of claim 2, wherein the static segmentation map comprises one or more background regions, one or more lane mark regions, and one or more road boundary regions.

4. The method of claim 1, wherein the dynamic objects represent moving objects in the surroundings, and the moving objects comprises moving vehicles and pedestrians on the freeway and the ramp.

5. The method of claim 1, wherein the method further comprises displaying the lane occupancy on a lane indicator light.

6. The method of claim 1, wherein the infrastructure camera is located at or near the merging point.

7. The method of claim 1, wherein the static segmentation map and the dynamic objects are generated further based on historical static segmentation maps of the surroundings.

8. The method of claim 1, wherein the method further comprises predicting moving speeds of the one or more dynamic objects and relative distances between the ego vehicle and the one or more dynamic objects.

9. The method of claim 8, wherein the method further comprises predicting collision probability between the ego vehicle and each of the one or more dynamic objects based on the lane occupancy, the moving speeds of the one or more dynamic objects, and the relative distances between the ego vehicle and the one or more dynamic objects.

10. The method of claim 9, wherein the method further comprises:
determining whether the collision probability is beyond a threshold probability; and
in response to determining that the collision probability is beyond the threshold probability, warning the ego vehicle of a potential collision with at least one of the one or more dynamic objects.

11. The method of claim 10, wherein the method further comprises in response to determining that the collision probability is beyond the threshold probability, operating the ego vehicle to avoid the potential collision.

12. A system for detecting one or more approaching vehicles, the system comprising:
an infrastructure camera operable to capture one or more images of surroundings of an ego vehicle, wherein the surroundings include a ramp, one or more lanes of a freeway, and the one or more approaching vehicles, and the ramp and the lanes share at least one merging point;
one or more processors operable to:
transform the one or more images of surroundings to a bird's eye view of the surroundings;
generate a static segmentation map and one or more dynamic objects in the static segmentation map based on the bird's eye view;
predict a lane occupancy of the ramp and the lanes based on range estimation of the ego vehicle and the one or more dynamic objects; and
transmit information about the predicted lane occupancy to the ego vehicle.

13. The system of claim 12, wherein the static segmentation map comprises labeled regions representing static objects and structures of roads, one or more background regions, one or more lane mark regions, and one or more road boundary regions.

14. The system of claim 12, wherein the dynamic objects represent moving objects in the surroundings, and the moving objects comprises moving vehicles and pedestrians on the freeway and the ramp.

15. The system of claim 12, wherein the one or more processors are further operable to display the lane occupancy on a lane indicator light.

16. The system of claim 12, wherein the infrastructure camera is located at or near the merging point.

17. The system of claim 12, wherein the static segmentation map and the dynamic objects are generated further based on historical static segmentation maps of the surroundings.

18. The system of claim 12, wherein the one or more processors are further operable to predict moving speeds of the one or more dynamic objects and relative distances between the ego vehicle and the one or more dynamic objects.

19. The system of claim 18, wherein the one or more processors are further operable to:
predict collision probability between the ego vehicle and each of the one or more dynamic objects based on the lane occupancy, the moving speeds of the one or more dynamic objects, and the relative distances between the ego vehicle and the one or more dynamic objects;
determine whether the collision probability is beyond a threshold probability; and
in response to determining that the collision probability is beyond the threshold probability, warn the ego vehicle of a potential collision with at least one of the one or more dynamic objects.

20. The system of claim 19, the one or more processors are further operable to, in response to determining that the collision probability is beyond the threshold probability, operate the ego vehicle to avoid the potential collision.
